(19) United States
(12) Patent Application Publication
(10) Pub. No.: US 2016/0324061 A1
(43) Pub. Date: Nov. 10, 2016

(54) HAND-OPERATED LANDSCAPING TOOL WITH BLADE TOOL HEAD AND CURVED HANDLE

(71) Applicant: JOHN W. LUCKETT, Urbana, IL (US)

(72) Inventor: JOHN W. LUCKETT, Urbana, IL (US)

(21) Appl. No.: 15/134,579

(22) Filed: Apr. 21, 2016

Related U.S. Application Data
(60) Provisional application No. 62/173,448, filed on Jun. 10, 2015.
(60) Provisional application No. 62/151,400, filed on Apr. 22, 2015.

(51) Int. Cl. A01B 1/24; A01G 3/06

(52) U.S. Cl. CPC A01B 1/246; A01G 3/06

(57) ABSTRACT

The invention provides a hand-operated landscaping tool that includes a generally flat blade tool head in combination with an elongated multi-angle handle. The blade tool head has a sharp leading edge for cutting through soil, and the elongated multi-angle handle allows the user to work beneath the soil in a generally horizontal direction while maintaining the user's hand in a position above the surface of the ground thereby minimizing contact with the ground and resulting injuries to the hand.

### CROSS-REFERENCE TO RELATED APPLICATIONS

This application claims priority to U.S. provisional application No. 62/151,400, filed Apr. 22, 2015, and provisional application No. 62/173,448, filed Jun. 10, 2015, the contents of which are incorporated herein by reference in their entirety.

### BACKGROUND

Edging and sod removal is a common task in gardening, landscaping and excavation operations. These tasks can be performed using a variety of motorized as well as non-motorized hand tools including shovels, spades, diggers and manual kick-type sod cutters. Motorized sod cutters are larger, expensive equipments, and manual, kick-type sod cutters also tend to be larger equipments requiring significant manual effort to operate. Other hand tools such as shovels, spades, diggers and hoes have limited effectiveness where sod removal for later reinstallation is desirable as these do not facilitate careful separation of the sod and subsurface root layer from the soil and lifting of the sod layer. Thus, often no effort is expended to recover sod for reinstallation.

### SUMMARY OF THE INVENTION

The invention provides a hand tool that enables the user to cut through the soil to separate the sod layer from the soil thereby enabling careful sod removal and reinstallation if desired. The hand-operated tool of the invention includes a generally flat blade tool head and an elongated multi-angle handle that in combination enable the user to maintain a comfortable position above the surface of the ground while working the blade tool head in a horizontal direction beneath the surface of the sod.

In one aspect, the invention provides a hand tool that has a generally flat blade tool head to which an elongated multi-angled handle is secured; the generally flat blade tool head having (a) a sharp leading edge effective for cutting through soil and (b) a trailing edge about which the elongated multi-angled handle is secured; and the elongated multi-angled handle having (a) a first section through which the handle is secured to the blade tool head, the first section extending rearwardly at a first angle away from the plane of the blade, (b) a second section to which the first section rearwardly extends and adjoins, the second section extending rearwardly at a second angle away from the plane of the blade, and (c) a third section to which the second section rearwardly extends and adjoins, the third section extending rearwardly at a third angle away from the plane of the blade, the third section optionally comprising a grip portion.

In some embodiments of a hand tool of the invention, the second and the third angles of the elongated multi-angled handle are substantially similar, the second angle being determined relative to the longitudinal axis of the first section, and the third angle being determined relative to the longitudinal axis of the second section. In some embodiments, the first angle is smaller than the second angle, the first angle being determined relative to the plane of blade, and the second angle being determined relative to the longitudinal axis of the first section. In some embodiments, the first angle is between about 1° to about 10° relative to the plane of the blade, the second angle is between about 10° to about 20° relative to the longitudinal axis of the first section, and the third angle is between about 10° to about 20° relative to the longitudinal axis of the second section. In some embodiments, the first angle is between about 2° to about 5° relative to the plane of the blade, the second angle is between about 12° to about 16° relative to the longitudinal axis of the first section, and the third angle is between about 12° to about 16° relative to the longitudinal axis of the second section.

In some embodiments of a hand tool of the invention, the lengths of the first and third sections of the elongated multi-angled handle are substantially similar. In some embodiments, the length of the second section of the elongated multi-angled handle is greater than that of the first section. In some embodiments, the length of the second section of the elongated multi-angled handle is about one and a half or about twice that of the first section.

In some embodiments of a hand tool of the invention, the elongated multi-angled handle is integrally formed with the first, second and third sections. In some embodiments, the hand tool is made of steel, aluminum, polypropylene, nylon, silicon, fiberglass, wood, foam or any combination thereof. In some embodiments, the generally flat blade tool head is made of one or more materials that include steel and the elongated multi-angled handle is made of one or more materials that include steel, wood, fiberglass, polypropylene or any combination thereof.

In some embodiments of a hand tool of the invention, the generally flat blade tool head includes a steel blade having a semi-circular shape with a sharp arcuate leading edge effective for cutting through soil and straight trailing edge about which the handle is secured.

In some embodiments of a hand tool of the invention, the elongated multi-angled handle is secured about the trailing edge of the generally flat blade tool head through soldering, brazing or welding.

In some embodiments of a hand tool of the invention, the generally flat blade tool head includes a tubular blade sleave connector integrally formed at the trailing portion of the blade tool head, the tubular blade sleave connector having a socket into which at least a portion of the first section of the elongated mutli-angled handle is inserted and through which the first section is secured to the blade tool head at the first angle. In some embodiments, the first section is secured to the blade sleeve connector using one or more rivets or an adhesive.

In some embodiments of a hand tool of the invention, the third section of the elongated multi-angled handle includes a grip portion. In some embodiments, the grip portion has a closed loop with a triangular or D-shape configuration. In some embodiments, the grip portion has a T-grip bar. In some embodiments, the grip portion includes a slip-resistant material, cushion material for comfort, or a combination thereof. In some embodiments, the grip portion includes a sleeve fitted to a portion of the third section, the sleeve having a slip-resistant material, a cushion material, or a combination thereof fit.

A hand tool of the invention allows the user to more effectively work the blade head in a substantially horizontal direction beneath the subsurface roots while maintaining the users hand in an elevated position above the surface of the ground to minimize contact with the ground and any associated injuries.

The substantially flat blade tool head with a sharp leading edge of any shape including curved or straight allows the blade to be inserted into the soil at select positions beneath the subsurface roots. The sharp leading edge enables efficient cutting through the soil and roots as needed. The elongated multi-angle handle that includes at least one bend, for example, two bends along its length, as well as the angle at which the handle is secured to the blade tool head, facilitates insertion into the soil and redirection of the tool to a substantially horizontal position beneath the roots to allow the user to cut through the soil to separate in tact sections of sod from the subsurface soil, while maintaining a comfortable position above the surface of the ground. The tool allows the user to work the blade tool head in a substantiallly horizontal direction beneath the surface of the turf while maintaining the user's hand above the ground to minimize contact with the ground and any associated injuries. The bends in the handle can be of substantially similar degrees, one bend occurring in an upwardly direction and the other in a downwardly direction. The bends can be, for example, about 15 to about 45 degrees. The angle at which the first section of the handle is secured to the blade head, i.e. the first angle, can be less than the angle at the bends in the body of the handle. The grip portion, which can be a straight grip bar, T-bar or loop in triangular or D-shape configuration, can include slip resistant or cushioned material for ease of handling or manipulation.

As used herein, the term “about” in reference to a specified amount means within 10% of the specified value, for example, within a range that is + or −10% of of the specified value, i.e., between 90% and 110% of the specified value.

The term “substantially” in reference to a specified quality or quantity means sufficient to achieve an intended function, result or effect of the quality or within 10% of the specified quantity, i.e., between 90% and 110% of the specified quantity.

Any feature or combination of features described herein are included within the scope of the present invention provided that the features included in any such combination are not mutually inconsistent as will be apparent from the context, this specification and the knowledge of one of ordinary skill in the art.

Unless otherwise defined, all technical and scientific terms used herein have the same meaning as commonly understood by one of ordinary skill in the art to which this invention belongs. In case of conflict, the present specification, including definitions, will control. In addition, the materials, methods, and examples are illustrative only and not intended to be limiting. Although methods and materials similar or equivalent to those described herein can be used to practice the invention, suitable methods and materials are described below.

All patents and publications referenced or mentioned herein are indicative of the levels of skill of those skilled in the art to which the invention pertains, and each such referenced patent or publication is hereby incorporated by reference to the same extent as if it had been incorporated by reference in its entirety individually or set forth herein in its entirety. Applicants reserve the right to physically incorporate into this specification any and all materials and information from any such cited patents or publications.

Other features and advantages of the invention will be apparent from the following detailed description and from the claims.

### DESCRIPTION OF THE FIGURES

FIG. 1 is a top perspective view of an embodiment of a hand tool of the invention having blade tool head 20 attached to elongated multi-angle handle 40 with T-grip bar 60.

FIG. 2 is a bottom perspective view of the hand tool 10 of FIG. 1.

FIG. 3 is a top view of hand tool 10 with sharp leading edge 22, trailing edge 24 and welded connection 30.

FIG. 4 is a bottom view of hand tool 10 illustrating elongated multi-angle handle 40 with integrally formed first section 40f, second section 40m, and third section 40r.

FIGS. 5A-5B are side views of hand tool 10 (5A) and a modified embodiment of hand tool 10 (5B).

FIG. 6 is a side view illustrating the angular relationships among first section 40f, second section 40m, and third section 40r of elongated multi-angle handle 40, in which Θ₁ represents the angle of first section 40f relative to plane b of blade 20, Θ₂ is the angle of second section 40m determined with respect to longitudinal axis a₁ of first section 40f, and Θ₃ is the angle of third section 40r determined with respect to longitudinal axis a₂ of second section 40m.

FIGS. 7A-7F are top views of exemplary embodiments of a blade tool head of the invention, the views illustrating various blade shapes and the positions of sharp leading edges 220a, 220b, 220c, 220d, 220e and 220f for cutting through soil and/or roots, as well as optional sharp side edges 260a, 260b, 260c, 260d, 260e and 260f and optional sharp trailing edges 240a, 240b, 240c, 240d, 240e and 240f demarcated by the dotted lines.

FIGS. 8A-8D are top and side views of exemplary embodiments of first section 400f-a, 400f-b, 400f-c and 400f-d and the manner in which they are secured to blade head 200a, 200b, 200c and 200d, respectively, including through welded connections 300a and 300b of first section 400f-a and 400f-b, respectively, as well as through integrally formed blade sleave connector 300c with socket into which an end portion of first section 400f-c is inserted and secured.

### DETAILED DESCRIPTION OF THE INVENTION

The invention provides a hand-operated tool that can be used to cut subsurface roots of the sod layer to separate the surface sod layer from the soil during sod removal and reinstallation. The hand-operated tool of the invention includes a generally flat blade tool head and an elongated multi-angle handle that in combination enable the user to maintain a comfortable position above the surface of the ground while working the blade tool head beneath the surface of the sod. More specifically, the tool allows the user to work the blade tool head in a substantiallly horizontal direction beneath the surface of the turf while maintaining the user's hand above the ground thereby minimizing contact with the ground and associated injuries.

### I. Illustrative Embodiment

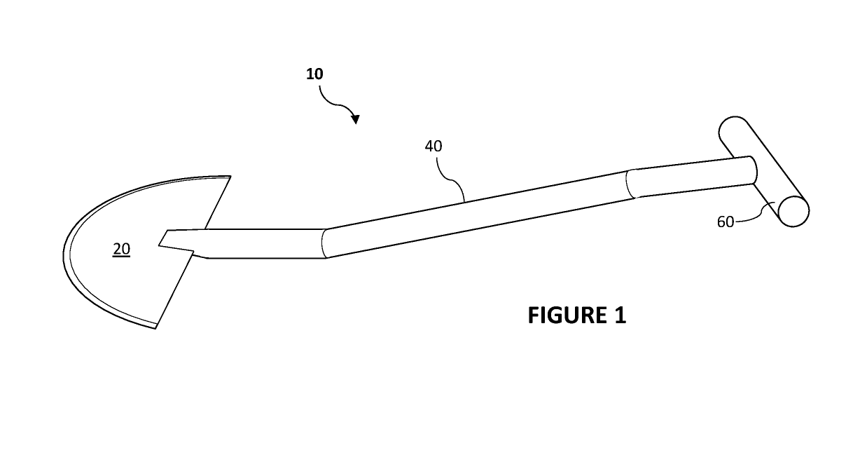

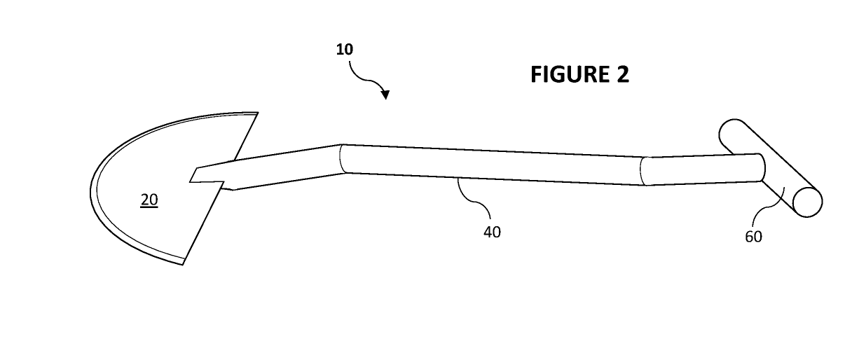

The figures depict an illustrative embodiment of the invention. FIGS. 1-2 provide a top and bottom perspective views, respectively, of tool 10, which includes blade tool head 20, elongated multi-angle handle 40, and T-grip bar 60.

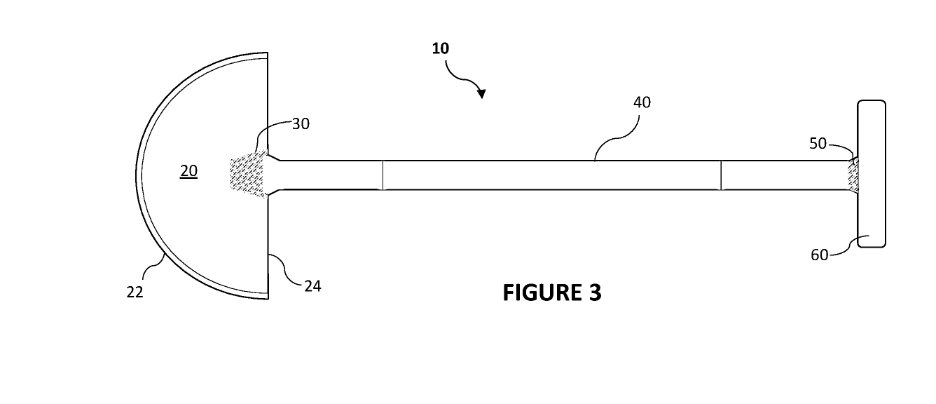

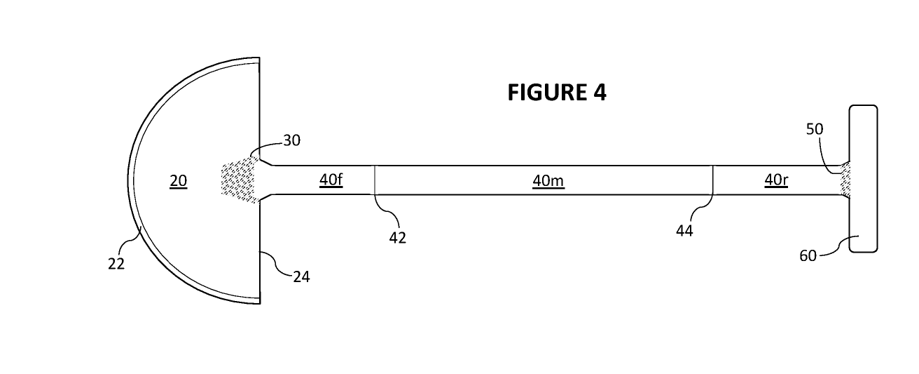

Blade tool head 20 is a generally flat, semi-circular plate having arcuate leading edge 22 and straight trailing edge 24. See FIGS. 3, 4, & 5 (top, bottom, and side views, respectively). The thickness of arcuate leading edge 22 tapers to form a sharp cutting edge effective for cutting through subsurface ground materials such as packed soil and plant and roots, for example, during the removal or harvesting of sod. Elongated, multi-angled handle 40 is attached to blade tool head 20 about straight trailing edge 24. Welded connection 30 forms the joint between elongated, multi-angled handle 40 and blade head 20, and welded connection 50 forms the joint between elongated multi-angle handle 40 and T-grip bar 60 as shown in FIGS. 3-4 (top and bottom views, respectively).

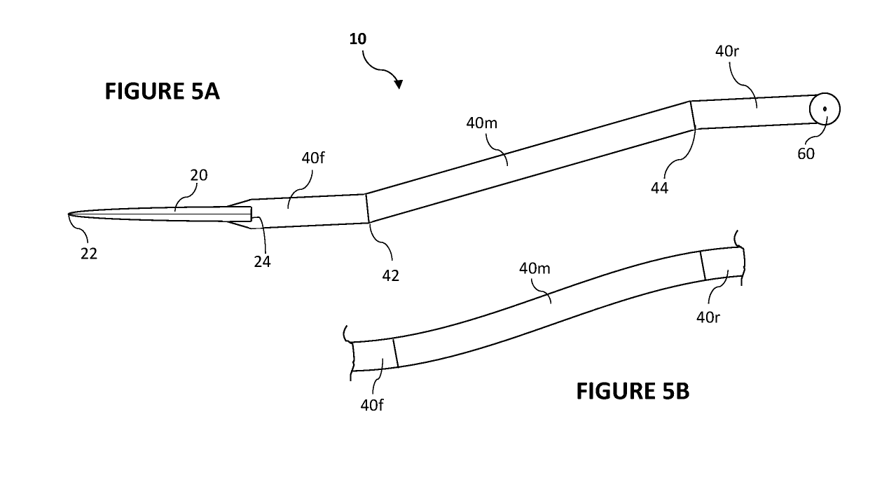

Elongated, multi-angled handle 40 has three adjoining body sections: first section 40f adjoining second section 40m at bend 42, which in turn adjoins third section 40r at bend 44. See FIGS. 4-5 (bottom & side views, respectively). The first end of section 40f is attached about trailing edge 24 of blade head 20, the connection being reinforced by welded connection 30. The second end of section 40f adjoins section 40m disposed between first section 40f and third section 40r. The other end of third section 40r is attached to T-grip bar 60 at welded connection 50. See FIGS. 3-4 (top and bottom views, respectively).

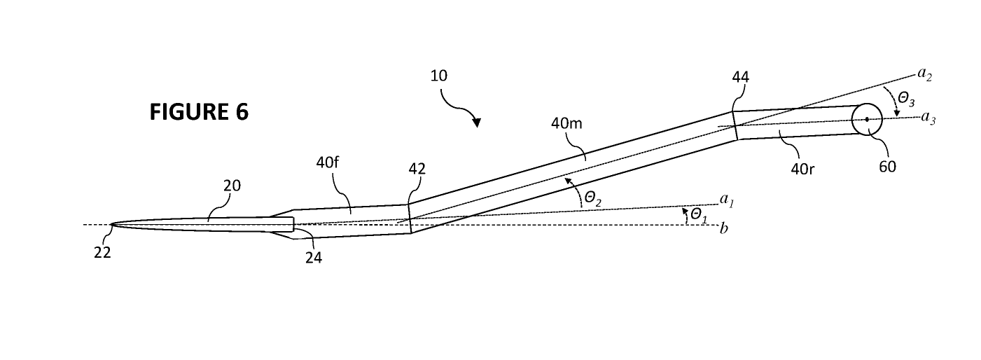

Adjoining handle sections 40f, 40m and 40r are in longitudinal alignment along a plane perpendicular to blade tool head 20 as shown in FIGS. 3 & 4 (top & bottom views, respectively) and in a multi-angled configuration relative to the plane of blade tool head 20 as illustrated in FIGS. 5-6 (side views). The plane of blade tool head 20 is represented by dotted line b (FIG. 6). First section 40f is upwardly angled relative to the plane of blade head 20 by about 1°, about 2°, about 3°, about 4°, about 5°, or about 6°, as represented by Θ₁. Second section 40m is upwardly angled with respect first section 40f by about 10°, about 11°, about 12°, about 13°, about 14° or about 15°, as represented by Θ₂. Third section 40r is downwardly angled with respect second section 40m by a similar amount of about 10°, about 11°, about 12°, about 13°, about 14° or about 15°, as represented by Θ₃.

As used herein, the term “about” in reference to a specified amount means within 10% of the specified value, for example, within a range that is + or −10% of of the specified value, i.e., between 90% of the specified value and 110% of the specified value.

First section 40f and third section 40r are about similar lengths, and second section 40m is about twice the length of the first and third sections. Welded connection 30 reinforces the joint between first section 40f and blade 20, and welded connection 50 reinforces the joint between section 40r and T-grip bar 60.

### II. Hand Tool for Sod Removal

In general, the invention provides a hand-operated tool that can be used to remove sod in gardening, landscaping or evacuation. The hand-operated tool includes a blade tool head, to which is secured an elongated multi-angle handle, optionally configured with a grip portion.

A. Generally Flat Blade Tool Head

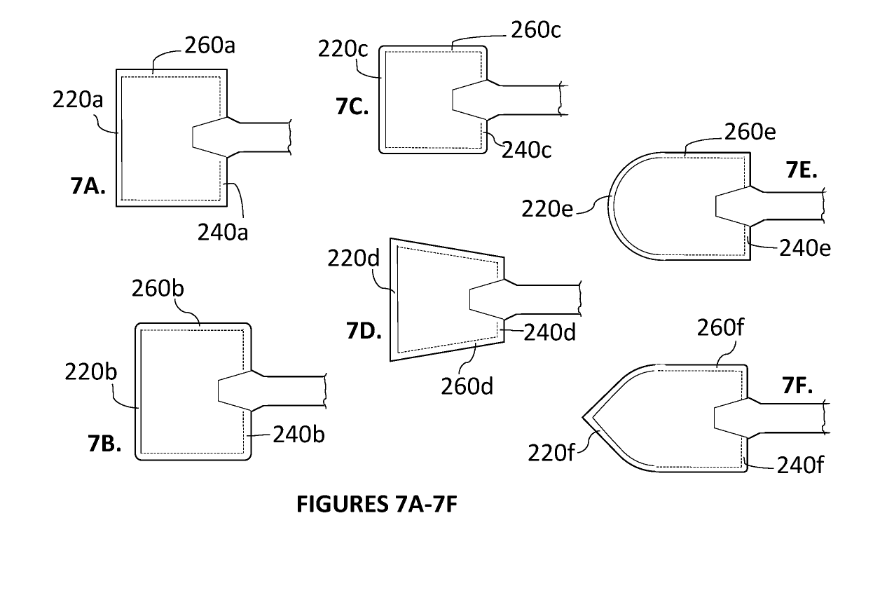

The blade tool head has a generally flat body with any regular or irregular shape. Non-limiting examples are shown in FIGS. 7A-7F. The blade tool head can have a generally rectangular shape (7A-7B), square shape (7C), flared or trapezoidal shape (7D), semi-circular shape (FIGS. 1-4), or other shapes (7E & 7F) as convenient. The blade tool head can have leading edges that are straight (FIGS. 7A-7D, edges 220a, 220b, 220c, and 220d) or arcuvate (FIGS. 7E-7F, edges 220e and 220f), or that include a pointed tip (FIG. 7F, edge 220f).

Regardless of the shape of the generally flat, blade tool head, the corners of the blade tool head can be pointed or sharp, for example, as shown in FIGS. 7A, 7D, and 7E, or rounded, for example, as shown in FIGS. 7B, 7C, and 7F.

Regardless of shape, the leading edge of the blade tool head can taper to form a sharp cutting edge as exemplified by edge 22 of tool 10 illustrated in FIGS. 3-6. Optionally, one or more of the side edges, e.g., edges 260a, 260b, 260c, 260d, 260e and 260f of FIGS. 7A-7F, as well as one or more trailing edges of a blade, e.g., edges 240a, 240b, 240c, 240d, 240e, and 240f, can also taper to form one or more sharp cutting edges. The cutting edges can be serrated or smooth (non-serrated). The blade tool head can be configured with one or more upturned sides with upper edges that can also be tapered to form sharp cutting edges (not shown).

The blade tool head can be composed of any material known to those of skilled in the art including, for example, steel such as sheet steel, aluminum or hard plastic. The blade tool head can have any convenient dimensions, for example, a width or length from about 0.05 meter to about 0.5 meter (m). The blade tool head can have any convenient size as measured by general blade surface area, for example, from about 0.03 to about 0.15 meter square (m²). The blade tool head can be any convenient thickness, for example, about 0.25 inch to about 1 inch, and any convenient weight, for example, about 0.3 kg to about 3.5 kg.

The blade tool head can be attached to an elongated multi-angle handle as described below.

B. Elongated Multi-Angled Handle

The elongated multi-angle handle can be formed of three adjoining sections, a forward first section, a middle second section and rear third section, each angled with respect to the adjacent section(s). The first section is attached to the blade tool head at one end and adjoins the second section at its other end. The second section is disposed between the first section and the rear third section. The rear third section adjoins the second section at one end and can be attached to an optional grip portion at its other end.

The first, second and third sections can have similar or different lengths. The first and third sections can have substantially similar lengths. The second section can have a longer length than that of the first or third section. For example, the second section can have a length that is about 1.25, about 1.5, about 2, about 2.25, or about 2.5 times longer than the length of the first or the third section.

The first section can be attached to the blade tool head at a first and upward angle (Θ₁) relative to plane b of the blade tool head thereby forming a first bend in hand-operated tool. Thus, the first section can extend in a slight upwardly direction and rearwardly toward the second section. The second section adjoins the first section at a second and upward angle (Θ₂) relative to longitudinal axis a₁ of the first section thereby forming a second bend in the hand-operated tool. Thus, the second section extends upwardly and rearwardly towards the rear third section. The rear third section adjoins the second section at a third and downward angle (Θ₃) relative to longitudinal axis a₂ of the second section thereby forming a third bend in the hand-operated tool. Each bend in the body of the hand-operated tool can be a sharp joint (FIG. 5A) or gentle turn or smooth curve (FIG. 5B) in the body of the hand-operated tool resulting in a curved or multi-angled handle that facilitates use or manipulation of the blade from an above-ground position when the blade tool head is beneath the sod layer.

The first and upward angle Θ₁ can be between about 1° to about 10° relative to plane b of the blade tool head, for example, between about 1° to about 10°. The second and upward angle Θ₂ can be between about 5° to about 35° relative to longitudinal axis a₁, for example, between about 5° to about 25°. The third and downward angle 0₃ can be between about 5° to about 35° relative to longitudinal axis a₂, for example, between about 5° to about 25°.

Thus, the first section can be attached to the blade tool head at an upward angle Θ₁ between about 1° to about 6° relative to the plane of the blade tool head, for example, about 2°, about 3°, about 4°, or about 5°. The second section can adjoin the first section at an upward angle Θ₂ of about 5° to about 35° relative to the longitudinal axis of the first section, for example, about 6°, about 7°, about 8°, about 9°, about 10°, about 11°, about 12°, about 13°, about 14°, about 15°, about 16°, about 17°, about 18°, about 19°, about 20°, about 21°, about 22°, about 23°, about 24°, about 25°, about 26°, about 27°, about 28°, about 29°, about 30°, about 31°, about 32°, about 33°, about 34°, or about 35°. The rear third section can adjoin the second section at a downward angle Θ₃ of about 5° to about 35° relative to the longitudinal axis of the second section, for example, about 6°, about 7°, about 8°, about 9°, about 10°, about 11°, about 12°, about 13°, about 14°, about 15°, about 16°, about 17°, about 18°, about 19°, about 20°, about 21°, about 22°, about 23°, about 24°, about 25°, about 26°, about 27°, about 28°, about 29°, about 30°, about 31°, about 32°, about 33°, about 34°, or about 35°.

In some embodiments of a hand tool of the invention, the first angle Θ₁ can be less than the second or third angle 73 ₂ or Θ₃. In some embodiments, the second angle Θ₂ can be greater than the third angle Θ₃. In some embodiments of the invention, the second and third angles Θ₂ and Θ₃ can be substantially similar, for example, about 6°, about 7°, about 8°, about 9°, about 10°, about 11°, about 12°, about 13°, about 14°, about 15°, about 16°, about 17°, about 18°, about 19°, about 20°, about 21°, about 22°, about 23°, about 24°, about 25°, about 26°, about 27°, about 28°, about 29°, or about 30°.

The elongated multi-angle handle can be constructed of any materials known to those of skilled in the art including, for example, aluminum, nylon, silicon, steel, plastic, wood such as ash or maple, or glass-reinforced plastic such as fiberglass. The elongated multi-angle handle can be of any convenient shape, size or dimension. For example, the elongated multi-angle handle can be about 20 inches long, the first section being about 4-5 inches in length, the second section about 10-12 inches in length, and the third section about 4-5 inches in length. The elongated multi-angle handle can be constructed as a tube with a generally, circular cross-section and optionally a hollow center.

C. Hand-operated Landscaping Tool of the Invention

The hand tool of the invention can be any convenient size. The hand tool can have a blade about 5 inches wide to about 24 inches wide and an elongated handle about 12 inches long to about 48 inches long. For example, the blade can be about 6 inches, about 7 inches, about 8 inches, about 9 inches, about 10 inches, about 11 inches, about 12 inches, about 13 inches, about 14 inches, about 15 inches, about 16 inches, about 17 inches, about 18 inches, about 19 inches, about 20 inches, about 21 inches, about 22 inches, about 23 inches, or about 24 inches at its widest. The elongated handle can extend rearwardly from the blade a length of, for example, about 10 inches, about 11 inches, about 12 inches, about 13 inches, about 14 inches, about 15 inches, about 16 inches, about 17 inches, about 18 inches, about 19 inches, about 20 inches, about 21 inches, about 22 inches, about 23 inches, about 24 inches, about 25 inches, about 26 inches, about 27 inches, about 28 inches, about 29 inches, about 30 inches, about 31 inches, about 32 inches, about 33 inches, about 34 inches, about 35 inches, about 36 inches, about 37 inches, about 38 inches, about 39 inches, about 40 inches, about 41 inches, about 42 inches, about 43 inches, about 44 inches, about 45 inches, about 46 inches, or about 47 inches.

The hand tool of the invention can be constructed of any material known to those of skilled in the art. The elongated handle can be constructed of the same material(s) as the blade tool head or of different materials than the blade tool head. For example, a hand tool of the invention can be constructed of steel, fiberglass, plastic, nylon, silicon, wood, or a combination thereof. A hand tool of the invention can include a blade tool head that is constructed of sheet steel, hard plastic or aluminum, and an elongated handle that is constructed of wood or plastic.

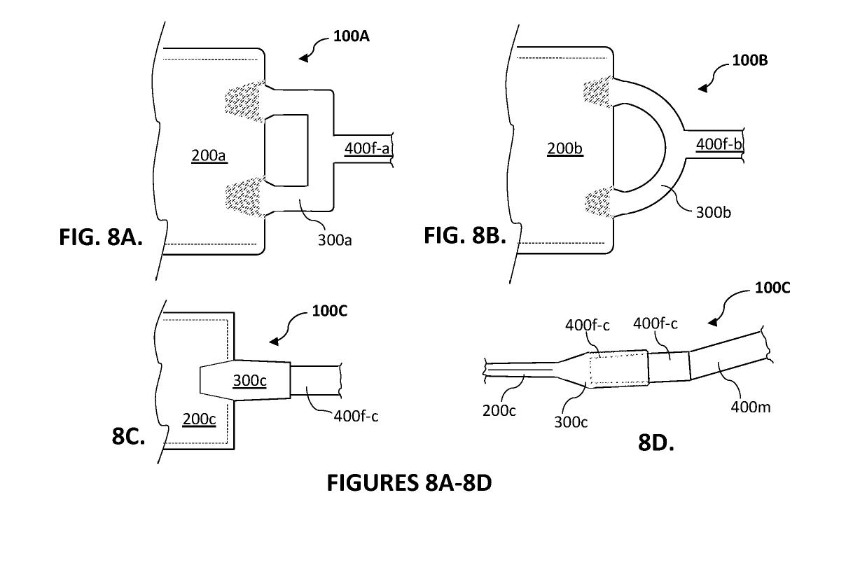

The elongated multi-angle handle can be attached to the blade tool head in any manner known to those of skill in the art. The elongated handle can be attached to the blade tool head as shown in FIGS. 1-7, in which the first section of the elongated handle is directly attached or secured about the trailing edge of the blade tool head using any mechanism, fastening means or fabrication or sculptural process for joining materials known to those of skill in the art. The handle-blade joint can be reinforced using additional materials, for example, the welded connection 30, as shown in FIGS. 3-7. The elongated handle can be attached to any region of the trailing edge and/or portion of the blade tool head, for example, at a center position as illustrated in FIGS. 1-7, or one or more positions nearer one or both ends of the trailing edge as illustrated for tool 100A and 100B shown in FIGS. 8A-8B, respectively.

The blade tool head also can be constructed with a blade sleeve connector for receiving and retaining the handle as illustrated for tool 100C shown in FIGS. 8C-8D. Tool 100C includes blade tool head 200c configured with blade sleeve connector 300c for receiving first section 400f-c of the elongated handle of tool 100C. Blade sleeve connector 300c is constructed with an internal cavity within which a portion of first section 400f-c is inserted and secured using any mechanism or fastening means known to those of skilled in the art including rivets or adhesives. The blade sleeve connector 300c can be integrally formed with the blade tool head or joined or secured to the blade tool head using any fastening means or fabrication or sculptural process for joining materials known to those of skill in the art.

Mechanisms for securing one component to another include, for example, the use of friction between opposing, interacting surfaces. Interacting opposing surfaces can be configured with matched threads, releasable spring-biased locking pins and matched recesses, or snap fit fastener components such as mating lip with matched undercut. Thus, fastening means include, for example, mechanical fasterners such as one or more rivets, lockbolts, screws, nuts, releasable spring-biased locking pins configured to engage with recesses, and similar snap fit fasteners such as mating lip on one componet configured to engage with an under cut on the other component. Fabrication or sculptural processes for joining materials include for example use of adhesives, welding, soldering, or brazing.

The hand tool of the invention can include a grip portion at one end. The grip portion can be in any convenient configuration including the configuration of a closed loop. The grip portion can be triangular or D-shape. The grip portion can be in the configuration of a T-grip bar of any convenient length, for example, about 5-7 inches in length, as illustrated in FIGS. 1-4 (T-grip bar 60). The grip portion can be constructed of one or more convenient materials known in the art including, for example, wood, steel, polypropylene, fiberglass, other plastics, a non-slip or slip-resistant material, a cushion material, or any combination thereof.

### Other Embodiments of the Invention

While the invention has been described in conjunction with the detailed description, the foregoing description is intended to illustrate and not limit the scope of the invention, which is defined by the scope of the appended claims. Specific embodiments of the invention described above do not limit the scope of the invention, which is described in the claims. Other aspects, advantages, and modifications are within the scope of the following claims.

The invention has been described broadly and generically herein. Each of the narrower species and subgeneric groupings falling within the generic disclosure also form part of the invention. In addition, the invention illustratively described herein suitably may be practiced in the absence of any element or elements, or limitation or limitations, which is not specifically disclosed herein as essential. The methods and processes illustratively described herein suitably may be practiced in differing orders of steps, and that they are not necessarily restricted to the orders of steps indicated herein or in the claims.

As used herein and in the appended claims, the singular forms “a,” “an,” and “the” include plural reference unless the context clearly dictates otherwise.

What is claimed is:

1. A hand tool comprising a generally flat blade tool head to which an elongated multi-angled handle is secured, wherein the generally flat blade tool head comprises:
(a) a sharp leading edge effective for cutting through soil, and
(b) a trailing edge about which the elongated multi-angled handle is secured, and the elongated multi-angled handle comprises:
(a) a first section through which the handle is secured to the blade tool head, the first section extending rearwardly at a first angle away from the plane of the blade,
(b) a second section to which the first section rearwardly extends and adjoins, the second section extending rearwardly at a second angle away from the plane of the blade, and
(c) a third section to which the second section rearwardly extends and adjoins, the third section extending rearwardly at a third angle away from the plane of the blade, the third section optionally comprising a grip portion.

2. The tool of claim 1, wherein the second and the third angles are substantially similar, the second angle being determined relative to the longitudinal axis of the first section, and the third angle being determined relative to the longitudinal axis of the second section.

3. The tool of claim 1, wherein the first angle is smaller than the second angle, the first angle being determined relative to the plane of blade, and the second angle being determined relative to the longitudinal axis of the first section.

4. The tool of claim 1, wherein the first angle is between about 1° to about 10° relative to the plane of the blade, the second angle is between about 10° to about 20° relative to the longitudinal axis of the first section, and the third angle is between about 10° to about 20° relative to the longitudinal axis of the second section.

5. The tool of claim 4, wherein the first angle is between about 2° to about 5° relative to the plane of the blade, the second angle is between about 12° to about 16° relative to the longitudinal axis of the first section, and the third angle is between about 12° to about 16° relative to the longitudinal axis of the second section.

6. The tool of claim 1, wherein the lengths of the first and third sections of the elongated multi-angled handle are substantially similar.

7. The tool of claim 1, wherein the length of the second section of the elongated multi-angled handle is greater than that of the first section.

8. The tool of claim 7, wherein the length of the second section of the elongated multi-angled handle is about twice that of the first section.

9. The tool of claim 1, wherein the elongated multi-angled handle is integrally formed with the first, second and third sections.

10. The tool of claim 1, which comprises steel, aluminum, polypropylene, nylon, silicon, fiberglass, wood, foam or any combination thereof.

11. The tool of claim 10, wherein the generally flat blade tool head comprises steel and the elongated multi-angled handle comprises steel, wood, fiberglass, polypropylene or any combination thereof.

12. The tool of claim 1, wherein the generally flat blade tool head comprises a steel blade having a semi-circular shape with a sharp arcuate leading edge effective for cutting through soil and straight trailing edge about which the handle is secured.

13. The tool of claim 1, wherein the elongated multi-angled handle is secured about the trailing edge of the generally flat blade tool head through soldering, brazing or welding.

14. The tool of claim 1, wherein the generally flat blade tool head comprises a tubular blade sleave connector integrally formed at the trailing portion of the blade tool head, the tubular blade sleave connector comprising a socket into which at least a portion of the first section of the elongated mutli-angled handle is inserted and through which the first section is secured to the blade tool head at the first angle.

15. The tool of claim 14, wherein the first section is secured to the blade sleeve connector using one or more rivets or an adhesive.

16. The tool of claim 1, wherein the third section of the elongated multi-angled handle comprises a grip portion.

17. The tool of claim 16, wherein the grip portion comprises a closed loop having a triangular or D-shape configuration.

18. The tool of claim 16, wherein the grip portion comprises a T-grip bar.

19. The tool of claim 16, wherein the grip portion comprises a slip-resistant material, cushion material for comfort, or a combination thereof.

20. The tool of claim 16, wherein the grip portion comprises a sleeve fitted to a portion of the third section, the sleeve comprising a slip-resistant material, a cushion material, or a combination thereof fit.
